(19) United States
(12) Patent Application Publication
(10) Pub. No.: US 2019/0061086 A1
(43) Pub. Date: Feb. 28, 2019

(54) MAGNETIC ADD-ON SYSTEM WITH VIBRATION AND ACOUSTIC SENSING CAPABILITIES FOR TOOL CONDITION MONITORING

(71) Applicants: THE REGENTS OF THE UNIVERSITY OF CALIFORNIA, Oakland, CA (US); INFINITE UPTIME, INC., Fremont, CA (US)

(72) Inventors: Raunak Bhinge, Berkeley, CA (US); Yung-Chih Chen, Fremont, CA (US); Kris Winer, Danville, CA (US)

(73) Assignees: THE REGENTS OF THE UNIVERSITY OF CALIFORNIA, Oakland, CA (US); INFINITE UPTIME, INC., Fremont, CA (US)

(21) Appl. No.: 16/118,109

(22) Filed: Aug. 30, 2018

Related U.S. Application Data
(63) Continuation of application No. PCT/US2017/019557, filed on Feb. 26, 2017.
(60) Provisional application No. 62/302,645, filed on Mar. 2, 2016.

(51) Int. Cl. B23Q 17/09; B23Q 17/12

(52) U.S. Cl. CPC B23Q 17/098; B23Q 17/0971; B23Q 17/12; B23Q 17/0995

(57) ABSTRACT

A magnetically attachable sensor assembly for sensing cutting tool operation. The magnetically attachable sensor assembly comprises an acoustic and vibration sensing apparatus, or sensor package, disposed in a housing having a portable, magnetic form factor for portability and easy clamping/attachment to a number of different surfaces.

### CROSS-REFERENCE TO RELATED APPLICATIONS

This application is a 35 U.S.C. § 111(a) continuation of PCT international application number PCT/US2017/019557 filed on Feb. 26, 2017, incorporated herein by reference in its entirety, which claims priority to, and the benefit of, U.S. provisional patent application Ser. No. 62/302,645 filed on Mar. 2, 2016, incorporated herein by reference in its entirety. Priority is claimed to each of the foregoing applications.

The above-referenced PCT international application was published as PCT International Publication No. WO 2017/151447 on Sep. 8, 2017, which publication is incorporated herein by reference in its entirety.

This application is related to U.S. patent application Ser. No. 15/973,253 filed on May 7, 2018, incorporated herein by reference in its entirety, which claims priority to, and the benefit of, PCT international application number PCT/US2016/059441, filed on Oct. 28, 2016, incorporated herein by reference in its entirety, which claims priority to, and the benefit of, U.S. provisional patent application Ser. No. 62/254,686 filed on Nov. 12, 2015, incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Appendix A referenced herein is a computer program listing in a text file entitled “BK-2016-109-2-US-Appendix-A.txt” created on Aug. 30, 2018 and having a 14 kb file size. The computer program code, which exceeds 300 lines, is submitted as a computer program listing appendix through EFS-Web and is incorporated herein by reference in its entirety.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This description pertains generally to machine tool operation, and more particularly to sensing for cutting tool operation.

### 2. Background Discussion

Manufacturing operations such as drilling and milling employ a cutting tool to remove material from a workpiece in order to create a predefined geometric feature. Due to the physics of the cutting process, the cutting tool wears out over time. Tool wear prediction and characterization has been a focus for researchers for many years. However, due to the complex phenomena in the machining process and the number of factors tool wear depends on, precise estimation of the tool condition is extremely difficult. A worn cutting tool has adverse effects on the quality of the feature produced as well as the machine tool itself. For example, cutting with a worn cutting tool may result in cutting tool failures which lead to unexpected downtime, poor quality production, and stress on the machine tool.

Manufacturing cutting tools are typically replaced after a set frequency, which heavily depends on the type of material, machine capability and past experience. Due to the complex machining process and large variability, the life of these cutting tools is a distribution and a set predefined frequency results in large inefficiencies. These inefficiencies can result in poor quality production, machine tool wear down and breakdown. It is currently difficult to monitor the current condition of the cutting tool in real-time to be able to diagnose the life of the cutting tool. Several attempts, especially involving the cutting tool or the tool holder, have been made at extracting data indicative of the condition of the cutting tool, but no add-on system for legacy machine tools has been created to date, which can be located on any part or fixture inside the machine tool.

### BRIEF SUMMARY

The technology described herein is a magnetic add-on device suitable for attachment to any metallic portion of a machine tool, especially for real-time operational data collection and analysis. Since a machine tool is metallic, and all fixtures tend to be steel-based for stiffness and strength, a magnetic add-on sensing apparatus is disclosed that enables quick installation and customized positioning for real-time data collection from the machine tool.

In one embodiment, the technology comprises a combination of acoustic and vibration sensors with the form factor of a magnetic add-on device for cutting tool monitoring applications. The technology of the present description is particularly useful for implementation in machine tools, material handling equipment and other like systems for real-time data collection. Beneficially, the technology of the present description provides manufacturers using machine tools or the like with a source of real-time operational data that is indicative of the tool condition.

Further aspects of the technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 shows a perspective view of a magnetically attachable sensor assembly for sensing cutting tool operation according to an embodiment of the technology described herein.

FIG. 2 is a perspective exploded view of the sensor assembly of FIG. 1.

FIG. 3 is a perspective view of the bottom case of the sensor housing of FIG. 1.

FIG. 4 shows a functional block diagram of the sensor electronics of the sensor assembly according to an embodiment of the technology described herein.

FIG. 5 is a schematic circuit diagram showing connections between certain components of the sensor electronics shown in FIG. 4.

FIG. 6 is a flow diagram showing steps of data acquisition and processing according to an embodiment of the technology described herein.

### DETAILED DESCRIPTION

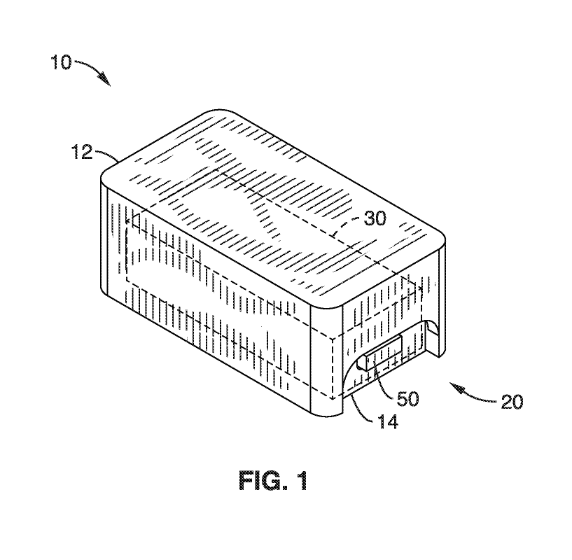

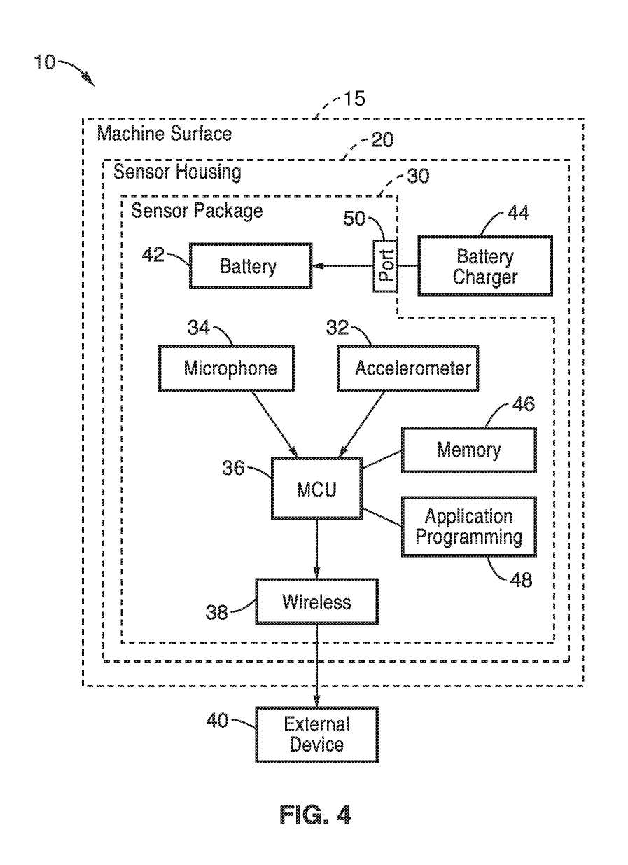

FIG. 1 shows a perspective view of a magnetically attachable sensor assembly 10 for sensing cutting tool operation according to an embodiment of the present technology. The magnetically attachable sensor assembly 10 comprises an acoustic and vibration sensing apparatus, or sensor package 30, disposed in a housing 20 having a portable, magnetic form factor for portability and easy clamping/attachment to a number of different surfaces. Housing 20 generally comprises an upper case 12 and bottom case 14 for retaining sensor package 30, and is configured to releasably mount to a magnetic surface 15 of the equipment or machinery to be monitored (see FIG. 4). A USB micro Type B port 50 may be incorporated to provide access to the data via a serial cable (not shown) and also provide recharging means for the on-board battery 42 (see FIG. 4).

As will be explained in further detail below, sensor package 30 is configured for monitoring the operation of cutting/machining tools while using a vise (not shown) or other type of surface of machinery or equipment.

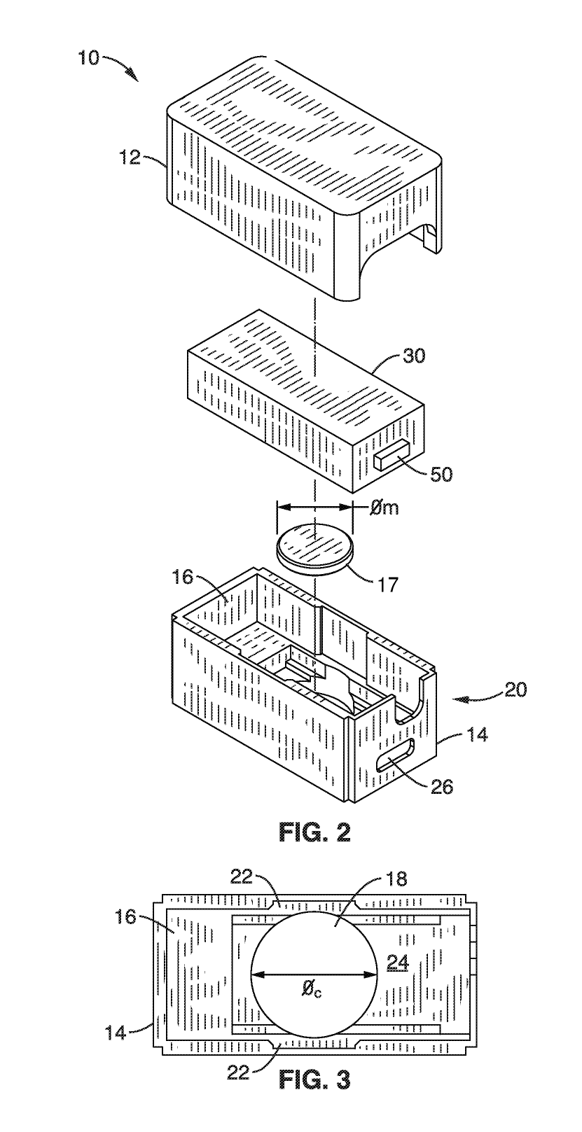

FIG. 2 shows a perspective exploded view of the sensor assembly 10. Sensor assembly 10 is shown with housing 20 and an upper case 12 that fits over bottom case 14 (e.g. via a press fit, interference fit, or the like) to house sensor package 30.

As shown in FIG. 2 and the top view of the bottom case in FIG. 3, the bottom case 14 is configured to receive an embedded magnet 17 in a hollowed-out circular pocket 18 on bottom surface 24. Pocket 18 has a diameter ϕ_{c} that closely matches, or is slightly larger than the diameter ϕₘ cylindrical magnet 17. Pocket 18 allows for the magnet 17 to be disposed flush to the bottom surface 24 to allow for a more compact fit of sensor package 30, which may be press fit into the bottom case 14 cavity 16. Pocket 18 also provides a more thin section of material below the magnet 17 so that a magnetic field of the magnet may more easily be transferred to a surface (e.g. workpiece surface 15) adjacent the bottom case 14 or housing 20. As seen in FIG. 3, a notch 22 may be positioned in each opposing inner side wall of the bottom case 14 to allow for more volume at the battery pocket 18, and promote extraction of either the sensor package 30 or magnet 17. Bottom case 14 may also comprise an aperture 26 to allow for access to the USB port 50 when the sensor package 30 is assembled in the housing 20.

While the two-piece housing configuration of FIG. 1 through FIG. 3 is a preferred configuration due to ease of fabrication and function, it is appreciated that such magnetic housing may be fabricated via an number of differing configurations and arrangements available to one skilled in the art. For example, the lower housing 14 may itself comprise a magnetic material, or otherwise be embedded or impregnated with a magnetic material for releasable mounting to a work surface.

FIG. 4 shows a functional block diagram of the sensor electronics assembly 30 of the magnetically attachable sensor assembly 10 for attaching/coupling to a machine surface 15 via the magnetic housing 20. In one embodiment, the machine surface comprises a surface of a vise or vise plate. However, other surfaces are also contemplated such that sensor assembly may be utilized as an add-on device for multiple types of machinery. In one embodiment, the components used in the sensor package 30 comprise an accelerometer 32 (inertial measurement unit) for measuring vibration and a microphone 34 for acoustic sensing. Both sensors 32, 34 are coupled to a processor (e.g. MCU 36), which is configured to control operation of the sensors 32, 34, in addition to process data received from sensors 32, 34, via application programming 48. Application programming 48 comprises instructions stored in memory 46 and executable on processor 36. Processor 36 is also coupled to wireless transceiver 38 for communication with an external device 40 in lie of or in compliment to serial port 50. Sensor package 30 is preferably powered via a battery 42, which may be recharged via charger 44.

In one exemplary embodiment, the accelerometer 32 comprises a Bosch BMX055 digital 9-axis accelerometer, microphone 34 comprises an InvenSense ICS-43432 low-noise microphone with I²S digital output, MCU 36 comprises a Teensy 3.2 microcontroller, wireless transceiver 38 comprises a CC2541 Bluetooth communication module, and battery 42 comprises a 3.7V 170 mAh LiPo (Lithium Polymer) battery. It is appreciated that the above embodiment is for illustrative purposes only, and other component configurations are also contemplated.

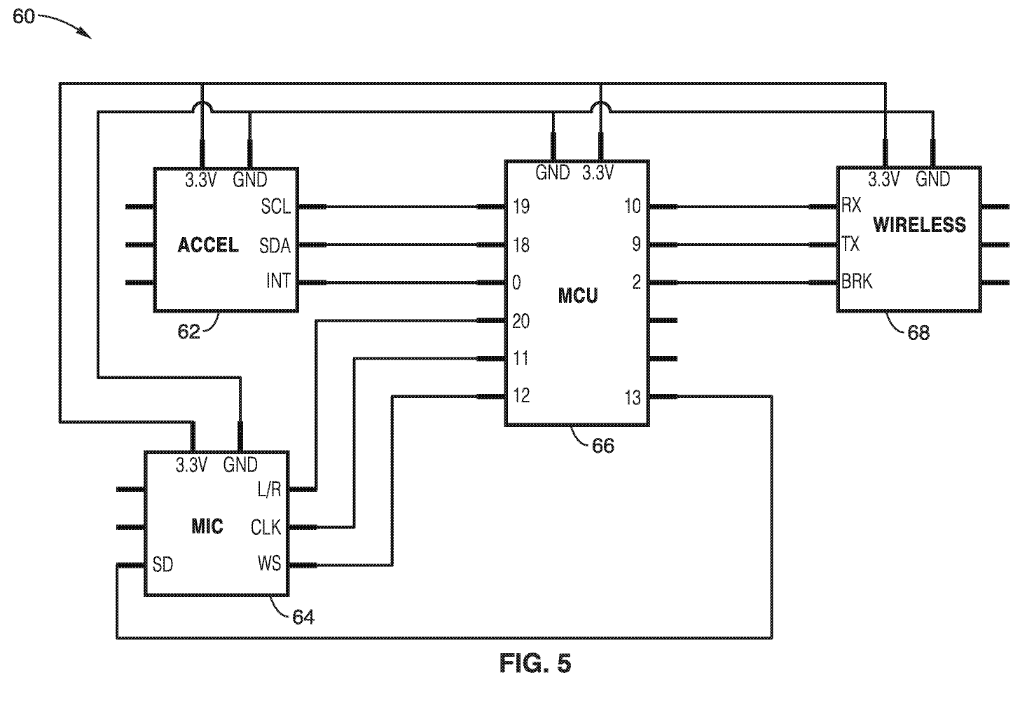

FIG. 5 is a schematic circuit diagram showing pinouts and connections between accelerometer 62, microphone 64, MCU 66 and wireless transceiver 68 electronics of a sensor package 60. It is appreciated that the connections are not restricted to those shown in FIG. 5, but different communication pins on the processor 66 (e.g. Teensy 3.2) can be used for the same results.

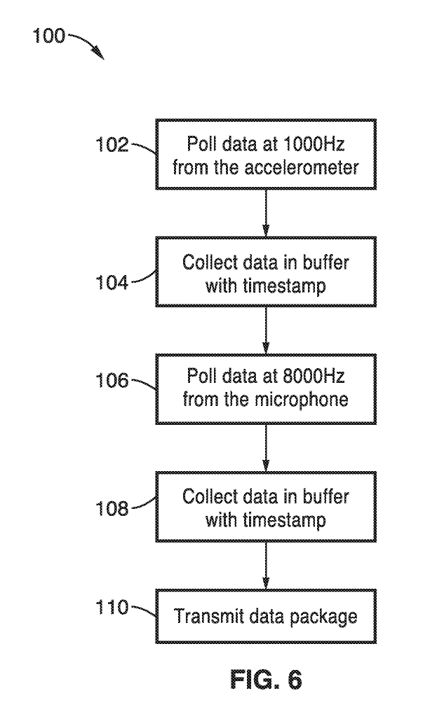

Referring now to sensing method 100 shown in the process flow diagram of FIG. 6, one preferred sensing embodiment utilizes two streams of real-time data (e.g. vibration data and acoustic data) that are acquired from sensing circuitry 30. At step 102, the accelerometer 32 is sampled at a frequency of 1000 Hz to provide high resolution data of the vibrations of the workpiece due to the cutting forces. Data from the accelerometer is collected in a buffer with timestamps at step 104. At step 106, the acoustic sensor (e.g., microphone 34) is sampled at 8000 Hz to provide high frequency information of the cutting forces, chatter frequencies, spindle frequencies, and the like, as well as the instantaneous condition of the tool and cutting conditions. Data from the acoustic sensor 34 is collected in a buffer with timestamps at step 108. Data from the acoustic sensor 34 and accelerometer 32 may be collected in the same buffer. At step 110, the two sources of data are combined together with their timestamps and sent wirelessly in a single data package through wireless data transceiver 38 or through serial port 50 to a data monitoring device 40 such as a computer, a process controller, and/or a visual display. In one embodiment, wireless communication is accomplished via a Bluetooth Low Energy (BLE) module.

While sensor electronics assembly 30 is primarily configured to acquire vibration data and acoustic data, it is appreciated that other forms of sensors, e.g. thermometers, pressure sensors, strain gauges, etc., may also be implemented to acquire additional sensor data (e.g. temperature, pressure, strain, etc.).

In one embodiment, the accelerometer 32 communicates using the I²C protocol, whereas the microphone communicates using the I²S protocol. The wireless (Bluetooth) data communication is over serial data transfer. The output data may be further processed using via external device 40 via applications such as tool condition monitoring and process optimization. Appendix A provides an embodiment of instructions contained in application programming 48 that may be executable on a processor 36 (e.g. Teensy 3.2 microcontroller) to perform the functions shown in method 10 of FIG. 6.

While the embodiments above are shown for use primarily with machine tools, it is appreciated that the technology is not restricted to machine tools alone, but can also be used in material handling equipment and other systems for real-time data collection.

Embodiments of the present technology may be described with reference to flowchart illustrations of methods and systems according to embodiments of the technology, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

It will further be appreciated that the terms “programming” or “program executable” as used herein refer to one or more instructions that can be executed by a processor to perform a function as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors. It will further be appreciated that as used herein, that the terms processor, computer processor, central processing unit (CPU), and computer are used synonymously to denote a device capable of executing the instructions and communicating with input/output interfaces and/or peripheral devices.

From the description herein, it will be appreciated that that the present disclosure encompasses multiple embodiments which include, but are not limited to, the following:

1. An apparatus for monitoring operation of a machine tool while machining a workpiece, the apparatus comprising: (a) a magnetic sensor housing; (b) a sensor package disposed within a cavity of the magnetic sensor housing; (c) wherein the sensor housing is configured to releasably attach to a machine surface associated with the machine tool via a magnetic attraction between the machine surface and the magnetic housing; and (d) at least one vibration sensor and acoustic sensor disposed within said sensor housing; (e) wherein said vibration sensor and acoustic sensor are configured for real-time monitoring of operational data of the machine tool.

2. The apparatus of any preceding embodiment, wherein the vibration sensor and acoustic sensor are disposed as a sensor package comprising: (i) a processor; (ii) an accelerometer coupled to the processor; (iii) an acoustic sensor coupled to the processor; and (iv) a memory storing instructions executable by the processor; (v) wherein said instructions, when executed by the processor, perform steps of acquiring vibration data and acoustic data from the accelerometer and acoustic sensor to perform real-time monitoring of the machine tool.

3. The apparatus of any preceding embodiment, the sensor package further comprising: (vi) a wireless transceiver connected to the processor, the wireless transceiver configured for transmitting the acquired vibration data and acoustic data to an external device.

4. The apparatus of any preceding embodiment: wherein the sensor housing comprises a cavity for securing the sensor package; and a magnet disposed at a surface of the housing configured to be positioned adjacent the machine surface.

5. The apparatus of any preceding embodiment, wherein the magnet is disposed within a pocket of said housing surface.

6. The apparatus of any preceding embodiment, wherein the housing comprises: a bottom case comprising said cavity and said pocket for housing the sensor package and magnet respectively; and an upper case configured to fit over the lower case to secure the sensor package within said cavity.

7. The apparatus of any preceding embodiment, wherein said instructions when executed by the processor, further perform steps comprising: acquiring vibration data from the accelerometer and storing the data in a buffer with timestamps; acquiring acoustic data from the acoustic sensor and storing the data in a buffer with timestamps; and combining the collected vibration and acoustic data for real-time monitoring of the machine tool.

8. The apparatus of any preceding embodiment, wherein said instructions when executed by the processor, further perform steps comprising: wirelessly sending the combined data in a single data package to an external data monitoring device.

9. The apparatus of any preceding embodiment, wherein said real-time monitoring comprises determining a condition of the machine tool from the combined data.

10. The apparatus of any preceding embodiment, wherein the accelerometer is sampled at a frequency to provide high resolution data of the vibrations of the workpiece due to cutting forces applied with the machine tool.

11. The apparatus of any preceding embodiment, wherein the acoustic sensor is sampled at a frequency to provide high frequency data of the workpiece due to cutting forces applied with the machine tool.

12. A method for monitoring operation of a machine tool, the method comprising: releasably coupling a sensor assembly to a machine surface associated with the machine tool via a magnetic attraction between the machine surface and the sensor assembly; acquiring vibration data and acoustic data from a location at said machine surface; and determining a condition of the machine tool as a function of the acquired accelerometer and acoustic data.

13. The method of any preceding embodiment, further comprising: wirelessly transmitting the acquired vibration data and acoustic data to an external device.

14. The method of any preceding embodiment, further comprising: acquiring vibration data from an accelerometer disposed within the sensor assembly and storing the data in a buffer with timestamps; acquiring acoustic data from an acoustic sensor within the sensor assembly and storing the data in a buffer with timestamps; and combining the collected vibration and acoustic data for real-time monitoring of the machine tool condition.

15. The method of any preceding embodiment, further comprising: wirelessly sending the combined data in a single data package to an external data monitoring device.

16. The method of any preceding embodiment, wherein acquiring vibration data comprises sampling the accelerometer at a frequency to provide high resolution data of the vibrations of the machine tool due to cutting forces applied with the machine tool.

17. The method of any preceding embodiment, wherein acquiring acoustic data comprises sampling the acoustic sensor at a frequency to provide high frequency data of the machine tool due to cutting forces applied with the machine tool.

18. An apparatus for monitoring operation of a machine tool while machining a workpiece, the apparatus comprising: (a) a magnetic sensor housing; (b) a sensor package disposed within a cavity of the magnetic sensor housing; (c) wherein the sensor housing is configured to releasably attach to a machine surface associated with the machine tool via a magnetic attraction between the machine surface and the magnetic housing; (d) wherein the sensor package comprises: (i) a processor; (ii) an accelerometer coupled to the processor; (iii) an acoustic sensor coupled to the processor; (iv) a memory storing instructions executable by the processor; and (v) wherein said instructions, when executed by the processor, perform steps of acquiring vibration data and acoustic data from the accelerometer and acoustic sensor to perform real-time monitoring of the machine tool.

19. The apparatus of any preceding embodiment, the sensor package further comprising: (vi) a wireless transceiver connected to the processor, the wireless transceiver configured for transmitting the acquired vibration data and acoustic data to an external device.

20. The apparatus of any preceding embodiment: wherein the sensor housing comprises a cavity for securing the sensor package; and a magnet disposed at a surface of the housing configured to be positioned adjacent the machine surface.

21. The apparatus of any preceding embodiment, wherein the magnet is disposed within a pocket of said housing surface.

22. The apparatus any preceding embodiment, wherein the housing comprises: a bottom case comprising said cavity and said pocket for housing the sensor package and magnet respectively; and an upper case configured to fit over the lower case to secure the sensor package within said cavity.

23. The apparatus of any preceding embodiment, wherein said instructions when executed by the processor, further perform steps comprising: acquiring vibration data from the accelerometer and storing the data in a buffer with timestamps; acquiring acoustic data from the acoustic sensor and storing the data in a buffer with timestamps; and combining the collected vibration and acoustic data for real-time monitoring of the machine tool.

24. The apparatus of any preceding embodiment, wherein said real-time monitoring comprises determining a condition of the machine tool from the combined data.

25. An apparatus, comprising: a magnetic add-on device; and vibration and acoustic sensors contained in the said device; said sensors configured for real-time monitoring of operational data from a vise used in a manufacturing machine tool.

26. The apparatus of any preceding embodiment, further comprising a wireless data communications interface connected to said sensors for transmitting data from said sensors to a remote location.

27. An apparatus, comprising: a housing with an embedded magnet; and vibration and acoustic sensors embedded in the housing; said sensors configured for real-time monitoring of operational data from such a portable add-on device used in a manufacturing machine tool.

28. The apparatus of any preceding embodiment, further comprising a wireless data communications interface connected to said sensors for transmitting data from said sensors to a remote location.

29. An apparatus for acoustic and vibration monitoring of a cutting tool while using a retrofit, the apparatus comprising: (a) a magnetic add-on device; (b) a sensor housing within the device body; and (c) a sensor system fitted within the sensor housing; (d) the sensor system comprising: (i) a signal processing unit; (ii) an accelerometer connected to the signal processing unit; (iii) an acoustic sensor connected to the signal processing unit; (iv) a wireless communications device connected to the signal processing unit; (v) the signal processing unit including a processor and a memory storing instructions executable by the processor, wherein said instructions, when executed, perform steps comprising: acquiring acoustic data from the accelerometer and storing the data in a buffer; acquiring vibration data from the acoustic sensor and storing the data in a buffer; and combining the collected vibration and acoustic data and sending the combined data wirelessly in a single data package through the wireless communications device, or using a wire, to a data monitoring system.

30. An apparatus for acoustic and vibration monitoring of a cutting tool, the apparatus comprising: (a) a 2-piece press-fitted sensor housing; (b) a magnet fitted within the housing; and (c) a sensor system fitted within the sensor housing; (d) the sensor system comprising: (i) a signal processing unit; (ii) an inertial measurement unit (IMU) connected to the signal processing unit; (iii) an acoustic sensor connected to the signal processing unit; (iv) a wireless communications device connected to the signal processing unit; (v) the signal processing unit including a processor and a memory storing instructions executable by the processor, wherein said instructions, when executed, perform steps comprising: acquiring acoustic data from the accelerometer and storing the data in a serial buffer; acquiring vibration data from the acoustic sensor and storing the data in a buffer; and combining the collected vibration and acoustic data and sending the combined data wirelessly in a single data package through the wireless communications device, or through a USB micro B cable, to a data monitoring system.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for monitoring operation of a machine tool while machining a workpiece, the apparatus comprising:
(a) a magnetic sensor housing;
(b) a sensor package disposed within a cavity of the magnetic sensor housing;
(c) wherein the sensor housing is configured to releasably attach to a machine surface associated with the machine tool via a magnetic attraction between the machine surface and the magnetic housing; and
(d) at least one vibration sensor and acoustic sensor disposed within said sensor package;
(e) wherein said vibration sensor and acoustic sensor are configured for real-time monitoring of operational data of the machine tool.

2. The apparatus of claim 1, wherein the vibration sensor and acoustic sensor are disposed as a sensor package comprising:
(i) a processor;
(ii) an accelerometer coupled to the processor;
(iii) an acoustic sensor coupled to the processor; and
(iv) a memory storing instructions executable by the processor;
(v) wherein said instructions, when executed by the processor, perform steps of acquiring vibration data and acoustic data from the accelerometer and acoustic sensor to perform real-time monitoring of the machine tool.

3. The apparatus of claim 2, the sensor package further comprising:
(vi) a wireless transceiver connected to the processor, the wireless transceiver configured for transmitting the acquired vibration data and acoustic data to an external device.

4. The apparatus of claim 1:
wherein the sensor housing comprises a cavity for securing the sensor package; and
a magnet disposed at a surface of the housing configured to be positioned adjacent the machine surface.

5. The apparatus of claim 4, wherein the magnet is disposed within a pocket of said housing surface.

6. The apparatus of claim 5, wherein the housing comprises:
a bottom case comprising said cavity and said pocket for housing the sensor package and magnet respectively; and
an upper case configured to fit over the lower case to secure the sensor package within said cavity.

7. The apparatus of claim 2, wherein said instructions when executed by the processor, further perform steps comprising:
acquiring vibration data from the accelerometer and storing the data in a buffer with timestamps;
acquiring acoustic data from the acoustic sensor and storing the data in a buffer with timestamps; and
combining the collected vibration and acoustic data for real-time monitoring of the machine tool.

8. The apparatus of claim 7, wherein said instructions when executed by the processor, further perform steps comprising:
wirelessly sending the combined data in a single data package to an external data monitoring device.

9. The apparatus of claim 7, wherein said real-time monitoring comprises determining a condition of the machine tool from the combined data.

10. The apparatus of claim 7, wherein the accelerometer is sampled at a frequency to provide high resolution data of the vibrations of the workpiece due to cutting forces applied with the machine tool.

11. The apparatus of claim 7, wherein the acoustic sensor is sampled at a frequency to provide high frequency data of the workpiece due to cutting forces applied with the machine tool.

12. A method for monitoring operation of a machine tool, the method comprising:
releasably coupling a sensor assembly to a machine surface associated with the machine tool via a magnetic attraction between the machine surface and the sensor assembly;
acquiring vibration data and acoustic data from a location at said machine surface; and
determining a condition of the machine tool as a function of the acquired accelerometer and acoustic data.

13. The method of claim 12, further comprising:
wirelessly transmitting the acquired vibration data and acoustic data to an external device.

14. The method of claim 12, further comprising:
acquiring vibration data from an accelerometer disposed within the sensor assembly and storing the data in a buffer with timestamps;
acquiring acoustic data from an acoustic sensor within the sensor assembly and storing the data in a buffer with timestamps; and
combining the collected vibration and acoustic data for real-time monitoring of the machine tool condition.

15. The method of claim 14, further comprising:
wirelessly sending the combined data in a single data package to an external data monitoring device.

16. The method of claim 14, wherein acquiring vibration data comprises sampling the accelerometer at a frequency to provide high resolution data of the vibrations of the machine tool due to cutting forces applied with the machine tool.

17. The method of claim 14, wherein acquiring acoustic data comprises sampling the acoustic sensor at a frequency to provide high frequency data of the machine tool due to cutting forces applied with the machine tool.

18. An apparatus for monitoring operation of a machine tool while machining a workpiece, the apparatus comprising:
(a) a magnetic sensor housing;
(b) a sensor package disposed within a cavity of the magnetic sensor housing;
(c) wherein the sensor housing is configured to releasably attach to a machine surface associated with the machine tool via a magnetic attraction between the machine surface and the magnetic housing;
(d) wherein the sensor package comprises:
(i) a processor;
(ii) an accelerometer coupled to the processor;
(iii) an acoustic sensor coupled to the processor;
(iv) a memory storing instructions executable by the processor; and
(v) wherein said instructions, when executed by the processor, perform steps of acquiring vibration data and acoustic data from the accelerometer and acoustic sensor to perform real-time monitoring of the machine tool.

19. The apparatus of claim 18, the sensor package further comprising:
(vi) a wireless transceiver connected to the processor, the wireless transceiver configured for transmitting the acquired vibration data and acoustic data to an external device.

20. The apparatus of claim 18:
wherein the sensor housing comprises a cavity for securing the sensor package; and
a magnet disposed at a surface of the housing configured to be positioned adjacent the machine surface.

21. The apparatus of claim 20, wherein the magnet is disposed within a pocket of said housing surface.

22. The apparatus of claim 21, wherein the housing comprises:
a bottom case comprising said cavity and said pocket for housing the sensor package and magnet respectively; and
an upper case configured to fit over the lower case to secure the sensor package within said cavity.

23. The apparatus of claim 18, wherein said instructions when executed by the processor, further perform steps comprising:
acquiring vibration data from the accelerometer and storing the data in a buffer with timestamps;
acquiring acoustic data from the acoustic sensor and storing the data in a buffer with timestamps; and
combining the collected vibration and acoustic data for real-time monitoring of the machine tool.

24. The apparatus of claim 23, wherein said real-time monitoring comprises determining a condition of the machine tool from the combined data.
